(19) United States
(12) Patent Application Publication
(10) Pub. No.: US 2022/0000706 A1
(43) Pub. Date: Jan. 6, 2022

(54) PORTABLE MASSAGE DEVICE WITH KNEADING MASSAGE AND PERCUSSION MASSAGE FUNCTION

(71) Applicant: Margita GRBIC, Mu?nchen (DE)

(72) Inventor: Margita GRBIC, Mu?nchen (DE)

(21) Appl. No.: 17/280,410

(22) PCT Filed: Sep. 30, 2019
(86) PCT No.: PCT/EP2019/076495

§ 371 Date: Mar. 26, 2021

(30) Foreign Application Priority Data
Sep. 28, 2018 (DE) 20 2018 105 588.7

(51) Int. Cl. A61H 23/00; A61H 23/02

(52) U.S. Cl. CPC A61H 23/006; A61H 23/0263; A61H 2201/0207; A61H 2201/1676; A61H 2201/1671

(57) ABSTRACT

The invention relates to a portable massage device with a sheath, having a variable-shape contact segment for resting on a body region to be massaged, a rotating massage head and a pummeling massage head, the rotating massage head and the pummeling massage head being arranged within the sheath and being set up to cause a change of shape of the contact segment during operation.

The invention relates to a portable massage device with a sheath, having a variable-shape contact segment for resting on a body region to be massaged, a rotating massage head and a pummeling massage head, the rotating massage head and the pummeling massage head being arranged within the sheath and being set up to cause a change of shape of the contact segment during operation.

Portable massage devices are used, for example, for the massage of the neck, the shoulders, the shoulder blades, the back, the hip, the legs, the abdomen or the feet, and serve for relaxation and heightening of well-being.

Unlike stationary massage devices, such as, for example, fixedly installed massage to benches or massage chairs, portable massage devices can be used at different locations or even on the go.

The portable massage devices which are described in the prior art can as a rule perform merely vibrating or percussive movements. They cannot, however, imitate human finger movements, in particular the kneading and pressing or pummeling movements.

DE 20 201 101 281 U1 describes a portable massage device which imitates the kneading movement. The massage device which is described comprises massage heads which rotate.

The present invention is based on the object of specifying a portable massage device which improves the massage comfort. Here, the massage effect is to provide as satisfactory a replication as possible of massage by way of a massaging person.

According to the invention, the said objects are achieved by way of the subject matter of Patent claim 1. Advantageous developments of the subject matter of the invention are characterized in the features of Subclaims 2 to 21.

According to the invention, a portable massage device (10) comprises
a sheath (11), having a variable-shape contact segment (12) for resting on a body region to be massaged,
a rotating massage head (13a, 13b),

and
a pummeling massage head (14a, 14b),

the rotating massage head (13a, 13b) and the pummeling massage head (14a, 14b) being arranged within the sheath (11) and being set up to cause a change of shape of the contact segment (12) during operation.

The advantages of the invention lie, in particular, in the fact that the human finger movements and/or the human massage movements, in particular kneading, pummeling and pressing, can be imitated in a highly satisfactory manner, and therefore a very pronounced massage effect is produced in the case of the person to be massaged.

According to the invention, a portable massage device according to the invention is preferred, the sheet having one or two loops (30a, 30b) which make it possible to hold the portable massage device during the massage. As a result, the device can be pressed onto the body even during the massage, which leads to a more pleasant massage.

According to the invention, a portable massage device according to the invention is preferred, the rotating massage head not being a wheel or cylinder which rotates about its axis.

According to the invention, a portable massage device according to the invention is preferred, the pummeling massage head (14a, 14b) being part of a massage mechanism which is arranged predominantly within a housing (15), the massage mechanism comprising, in addition to the pummeling massage head (14a, 14b), a drive motor (16), a rotary shaft (17), an eccentric wheel (18a, 18b) and a vibration arm (19a, 19b), the drive motor (16) being drive-connected to the rotary shaft (17), in order to drive the rotary shaft (17) for rotation, and the eccentric wheel (18a, 18b) being placed fixedly on the rotary shaft (17), and the vibration arm (19a, 19b) having an opposite first end and a second end, and the first end of the vibration arm (19a, 19b) being provided with a bore (191) and being placed rotatably on the eccentric wheel (18a, 18b), and a slot (192) being provided at the central position of the vibration arm, the length direction of which slot (192) is identical to the length direction of the vibration arm (18a, 18b), and the vibration arm (18a, 18b) being connected pivotably to the housing (15) such that it can be moved through the slot (192), whereas the second end of the vibration arm extends out of the housing (15) and is connected to the pummeling massage head (14a, 14b).

According to the invention, a portable massage device according to the invention is preferred, in each case two groups of the eccentric wheels (18a, 18b), the vibration arms (19a, 19b) and the massage heads (14a, 14b) being provided, and being arranged in each case at the two ends of the rotary shaft (17).

According to the invention, a portable massage device according to the invention is preferred, the eccentric directions of the two groups of the eccentric wheels (18a, 18b) being arranged in a reversed manner.

According to the invention, a portable massage device according to the invention is preferred, a relief hole for guiding through the vibration arm (19a, 19b) being provided on the housing (15), a limiting groove being provided on the surface of the housing on an opposite side of the relief hole, and the vibration arm (19a, 19b) being arranged so as to pass through in the relief hole, and a pivoting shaft being arranged so as to pass through in the slot (192) at the central position of the vibration arm, and the pivoting shaft being arranged fixedly in the limiting groove, and the opening of the limiting groove being closed by way of a fixed covering.

According to the invention, a portable massage device according to the invention is preferred, a mounting groove (21) being provided in the housing (15), the rotary shaft (17) being fastened rotatably in the mounting groove (21) by way of a bearing (20), in order in turn to realize a positioning means in the housing (15).

According to the invention, a portable massage device according to the invention is preferred, a first belt wheel (22) being connected to a drive end of the drive motor (16), whereas a second belt wheel (23) is placed on the rotary shaft (17), and the first belt wheel and the second belt wheel realizing a transmitting connection to one another by way of a belt (24), and the drive motor (16) driving the rotary shaft (17) for rotation by way of a transmission of the first belt wheel (22), the belt (24) and the second belt wheel (23).

According to the invention, a portable massage device according to the invention is preferred, a mounting platform being arranged at the second end of the vibration arm (19a, 19b), the pummeling massage head (14a, 14b) being fastened to the mounting platform.

According to the invention, a portable massage device according to the invention is preferred, the pummeling massage head (14a, 14b) having a hollow hemispherical structure, a first positioning step (141) being arranged on the pummeling massage head, whereas a second positioning step which fits together with the first positioning step (141) is arranged on the mounting platform of the vibration arm (19a, 19b), and the pummeling massage head (14a, 14b) being snapped onto the mounting platform, and a positioning connection being realized by way of the fitting together of the first positioning step (141) and the second positioning step.

According to the invention, a portable massage device according to the invention is preferred, associated screw holes being provided, furthermore, between the pummeling massage head (14a, 14b) and the mounting platform, and the screw connections between them being realized by means of screw locking elements.

According to the invention, a portable massage device according to the invention is preferred, the housing (15) comprising an upper housing (15b) and a lower housing (15a) which engage into one another, the drive motor (16) and the rotary shaft (17) being arranged on the lower housing (15a), whereas the slot (192) is connected pivotably to the upper housing (15b) such that it can be moved at the centre position of the vibration arm (19a, 19b).

According to the invention, a portable massage device according to the invention is preferred, the rotating massage head (13a, 13b) being part of a massage mechanism which is arranged predominantly within a housing, the massage mechanism comprising, in addition to the rotating massage head (13a, 13b), a drive motor (16) and a rotary shaft (25a, 25b), and the drive motor (16) being drive-connected to the rotary shaft (25a, 25b), in order to drive the rotary shaft (25a, 25b) for rotation, and one end of the rotary shaft (25a, 25b) extending out of the housing and being connected fixedly to the rotating massage head (13a, 13b).

According to the invention, a portable massage device according to the invention is preferred, the driving connection between the drive motor (16) and the rotary shaft (25a, 25b) taking place via a worm (26a, 26b) which is connected to a drive end of the drive motor (16), a two-stage gearwheel (27a, 27b) which is arranged on the worm (26a, 26b), and a single-stage gearwheel (28a, 28b) which is arranged on the two-stage gearwheel (27a, 27b) and on which the rotary shaft (25a, 25b) is arranged, the two-stage gearwheel (27a, 27b) engaging with the worm (26a, 26b), and the single-stage gearwheel (28a, 28b) engaging with the two-stage gearwheel (27a, 27b).

According to the invention, a portable massage device according to the invention is preferred, in each case two groups of the worms (26a, 26b), the single-stage gearwheels (28a, 28b), the single-stage gearwheels (28a, 28b), the rotary shafts (25a, 25b) and the rotating massage heads (13a, 13b) being provided, and being arranged in each case at the two ends of the drive shafts of the drive motor (16).

According to the invention, a portable massage device according to the invention is preferred, the rotating massage head (13a, 13b) having one, two or more elevations which are arranged around the rotational axis (131) of the massage head.

According to the invention, a portable massage device according to the invention is preferred, the one, two or more elevations being arranged in such a way that they are in contact with the variable-shape contact segment (12), and therefore bring about a shape change of the contact segment (12) during operation and preferably massage the body region to be massaged.

According to the invention, a portable massage device according to the invention is preferred, the portable massage device (10) comprising merely one drive motor (16) and one housing (15), and the drive motor (15) and the massage mechanism for the rotating massage head (13a, 13b) and the pummeling massage head (14a, 14b) being arranged in the housing.

According to the invention, a portable massage device according to the invention is preferred, the massage device comprising, furthermore, a control unit (29), a control output of the control unit (29) being connected to an input of the drive motor (16) or the drive motors, in order to actuate the operation of the drive motor (29).

According to the invention, a portable massage device according to the invention is preferred, the sheath (11) consisting completely or predominantly of a textile or leather.

According to the invention, a portable massage device according to the invention is preferred, one or a plurality of heating elements being arranged within the sheath (11) and being set up to cause heating of the contact segment (12) during operation.

According to the invention, a portable massage device according to the invention is preferred, the one or the plurality of heating elements being arranged in the rotating massage head (13a, 13b) and/or the pummeling massage head (14a, 14b).

According to the invention, a portable massage device according to the invention is preferred, the rotating massage head (13a, 13b) and the pummeling massage head (14a, 14b) being different massage heads.

Our own tests have shown that, as a result, a particularly relaxing massage can be achieved in comparison with massage devices, in the case of which the rotating massage head also at the same time carries out a pummeling movement. In this case, the contact of the massage head is interrupted during the rotating movement of the massage head as a result of the pummeling movement, with the result that the massage does not have as pleasant an effect as in the case of a device, in the case of which there are two different massage heads.

According to the invention, the motor is preferably driven electrically. It is particularly preferred here according to the invention if the motor is supplied with electric energy by way of an accumulator, and the accumulator is preferably arranged within the sheath (11).

According to the invention, a portable massage device according to the invention is preferred, the portable massage device having a weight of below 10 kg, preferably a weight of below 5 kg, particularly preferably a weight of below 3 kg. It has been shown in our tests that it is preferred in the case of portable massage devices if they are light and can be readily carried by the user. In the case of the massage device being placed onto the region to be massaged of the body, in particular, it is advantageous if the massage device has a weight of below 5 kg, preferably below 3 kg, since the pressure on the body does not have an unpleasant effect as a result.

In the following text, preferred embodiments of the invention will be explained and described in greater detail with reference to the appended drawings, in which:

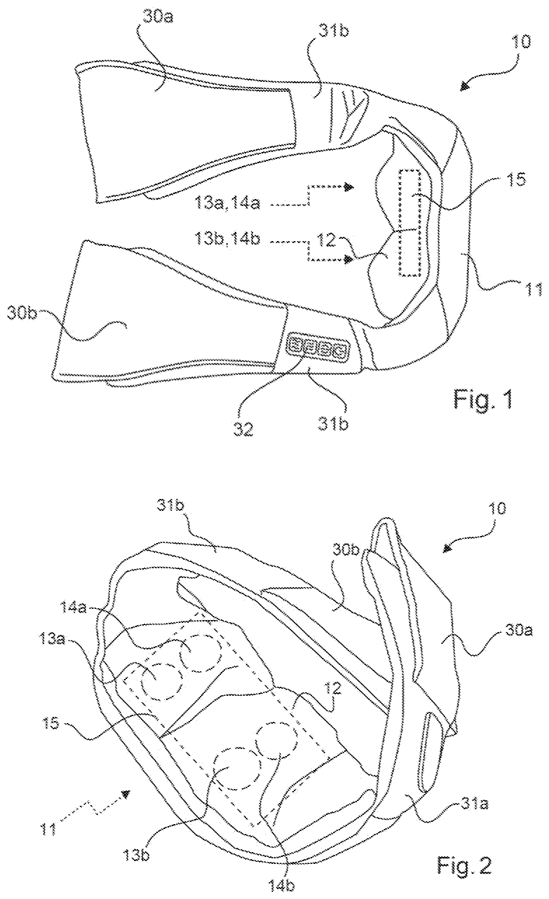

FIG. 1 shows one exemplary embodiment of the massage device according to the invention in a diagrammatic illustration,

FIG. 2 shows the massage device according to the invention from FIG. 1 in a further diagrammatic illustration,

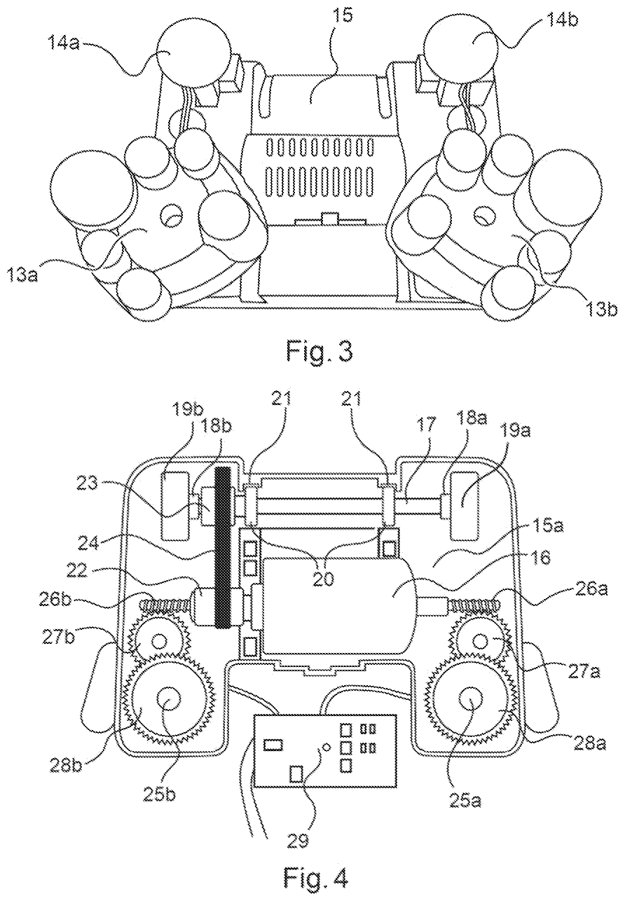

FIG. 3 shows a diagrammatic structure view of a housing with pummeling massage heads and rotating massage heads, in plan view,

FIG. 4 shows a diagrammatic structure view of the massage mechanism in an open housing with a missing lower housing part, in a view from below,

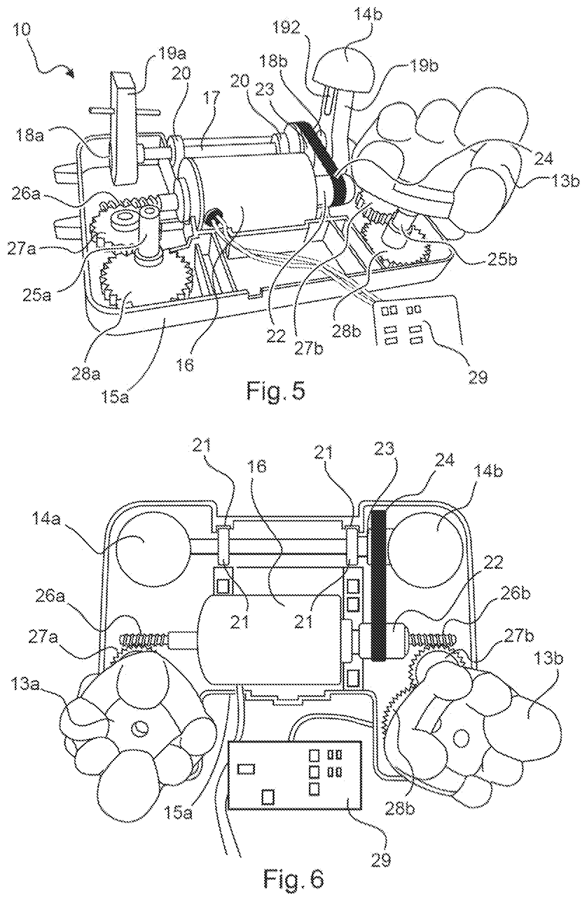

FIG. 5 shows a diagrammatic structure view of the housing from FIG. 3 with a missing upper housing part and a view of the massage mechanism,

FIG. 6 shows the structure view from FIG. 1 in a further diagrammatic illustration,

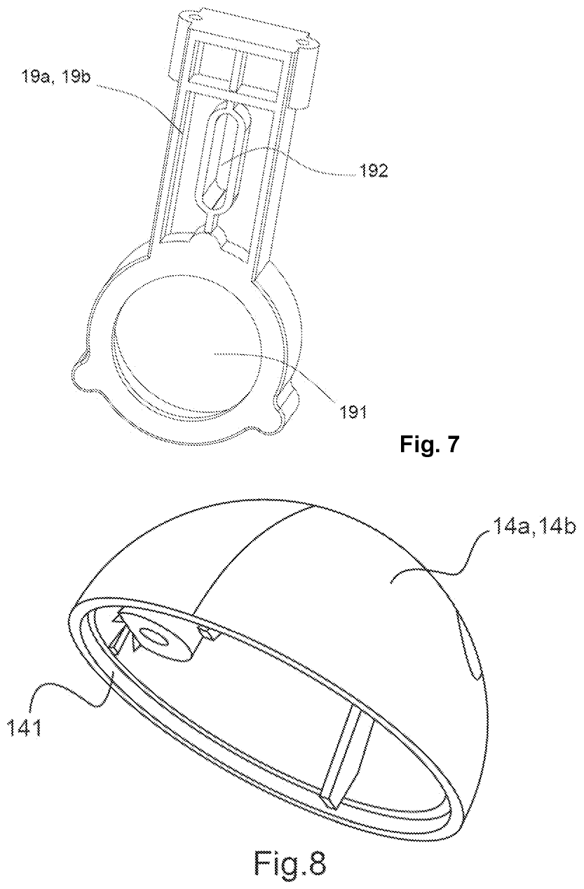

FIG. 7 shows a diagrammatic structure view of a vibration arm,

FIG. 8 shows a diagrammatic structure view of a pummeling massage head, and

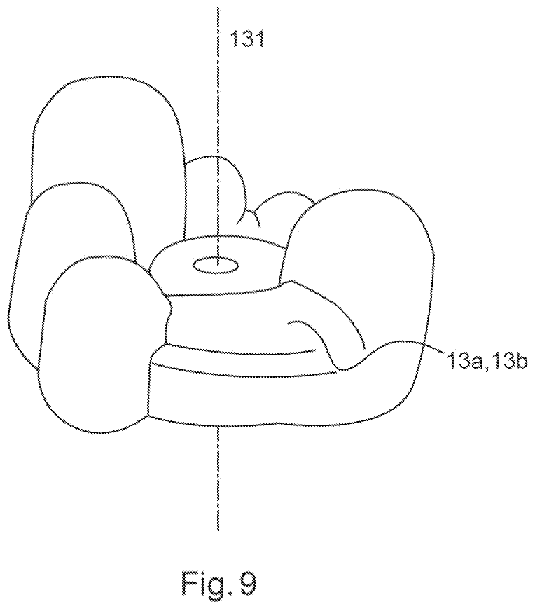

FIG. 9 shows a diagrammatic structure view of a rotating massage head.

According to FIG. 1 and FIG. 2, the portable massage device 10 comprises a sheet 11, in which two rotating massage heads 13a, 13b and two pummeling massage heads 14a, 14b are arranged, and a variable-shape contact segment 16.

The two rotating massage heads 13a, 13b and the two pummeling massage heads 14a, 14b are set up to cause a shape change of the contact segment 12 during operation. Moreover, the portable massage device 10 comprises a plurality of heating elements which are arranged within the main body 11 and are set up to cause heating of the contact segment 12 during operation.

The variable-shape contact segment 12 serves for placing onto a body region to be massaged. The sheath 11 and the contact segment 12 are configured from a textile material. Moreover, the contact segment 12 is padded.

The sheet 11 has two elongate side parts 31a, 31b which extend in each case laterally from the contact segment 12. The elongate side parts 31a, 31b of the sheath 11 in each case have a loop 30a, 30b which can be gripped by the user. An operating unit 32 is arranged on a side part 33a, which operating unit 32 makes it possible for the user of the massage device 10 to control the latter. The operating unit 32 is connected electrically to the control unit 29.

FIG. 3 shows the housing 15, with two rotating massage heads 13a, 13b and two pummeling massage heads 14a, 14b. The rotating massage heads comprise in each case six elevations which are arranged around the rotational axis of the respective massage head.

FIG. 4 shows a diagrammatic structure view of the massage mechanism. To this end, the lower housing part 15a has been removed from the housing 15. The drive motor 16 which comprises two drive shafts is arranged centrally. The rotating massage heads (not depicted here) are arranged in each case on a rotary shaft 25a, 25b, and the drive motor 16 is drive-connected to the rotary shafts 25a, 25b, in order to drive the rotary shafts 25a, 25b for rotation. The ends of the rotary shaft 25a, 25b extend out of the upper housing part 15b and are connected fixedly to the rotating massage heads. The drive-connection between the drive motor 16 and the rotary shafts 25a, 25b takes place via the worms 26a, 26b which are connected in each case to a drive end of the drive motor 16, the two-stage gearwheels 27a, 27b which are arranged in each case on the worms 26a, 26b, and two single-stage gearwheels 28a, 28b which are arranged in each case on the two-stage gearwheel 27a, 27b and are arranged in each case on the rotary shafts 25a, 25b. Here, in each case one two-stage gearwheel 27a, 27b engages with a worm 26a, 26b, and in each case one single-stage gearwheel 28a, 28b engages with in each case one two-stage gearwheel 27a, 27b. A first belt wheel 22 is connected to a drive end of the drive motor 16, and a second belt wheel 23 is placed on the rotary shaft 17, the first belt wheel 22 and the second belt wheel 23 realizing a transmitting connection with one another by way of a belt 24, and the drive motor 16 driving the rotary shaft 17 for rotation by way of a transmission of the first belt wheel 22, the belt 24 and the second belt wheel 23. The eccentric wheels 18a, 18b are placed fixedly onto in each case one end of the rotary shaft 17, and the vibration arm 19a, 19b is placed rotatably on the eccentric wheel 18a, 18b. The ends of the vibration arms 19a, 19b extend out of the upper part of the housing 15b, and are connected to the pummeling massage heads 14a, 14b (not pictured here). A control output of the control unit 29 is connected to an input of the drive motor 16, in order to actuate the operation of the drive motor 29. The control unit 29 is connected electrically to an energy supply and, in addition, to the operating unit 32, in order to make control by way of the user possible.

FIG. 5 shows the massage mechanism from FIG. 4 in a view from the opposite side; to this end, the upper housing part 15b has been removed from the housing 15, while the lower housing part 15a is depicted. For improved clarity, in each case only one pummeling massage head 14a and one rotating massage head 13a are depicted. The vibration arms 19a, 19b are provided in each case with a bore 191 and are placed rotatably on the eccentric wheels 18a, 18b. The eccentric wheels 18a, 18b are rotated by way of a rotation of the rotary shaft 17, and the vibration arms 19a, 19b are driven in each case in a to and fro movement along the length direction of the vibration arms. In the present exemplary embodiment, the eccentric directions of the two groups of the eccentric wheels (18a, 18b) are arranged in a reversed manner, in order to achieve crossed percussion, in order that an improved massage effect can be realized.

FIG. 6 shows the massage mechanism from FIG. 5 in a plan view, the two massage heads being depicted.

FIG. 7 shows a vibration arm 19a, 19b with a slot 192 which is arranged at the central position of the vibration arm 19a, 19b and can be connected pivotably to the upper housing 15b such that it can be moved. In the present exemplary embodiment, a pivoting shaft is provided so as to pass through in the slot 192, the pivoting shaft being arranged fixedly in the upper part of the housing 15b. A bore 191 is provided at the lower end of the vibration arm, which bore 191 can be placed rotatably on the eccentric wheel 18a, 18b.

FIG. 8 shows a pummeling massage head 14a, 14b which has a hollow hemispherical structure. A first positioning step 141 is arranged on the massage head 14a, 14b, and the one second positioning step which fits together with the first positioning step 141 can be arranged on the mounting platform which can be fastened to the vibration arm 19a, 19b, with the result that the massage head 14a, 14b can be snapped onto the mounting platform.

FIG. 9 shows a rotating massage head 13a, 13b which has six elevations which are arranged around the rotational axis 131 of the massage head. The rotating massage head 13a, 13b can be fastened to one end of the rotating shaft 25a, 25b.

### LIST OF REFERENCE SIGNS

10 Portable massage device
11 Sheath
12 Variable-shape contact segment
13a, 13b Rotating massage head
131 Rotational axis of the rotating massage head
14a, 14b Pummeling massage head
15 Housing
15a Lower part of the housing 15
15b Upper part of the housing 15
16 Drive motor
17 Rotary shaft
18a, 18b Eccentric wheel
19a, 19b Vibration arm
191 Bore
192 Slot
20 Bearing
21 Mounting groove for bearing 20
22 First belt wheel
23 Second belt wheel
24 Belt
25a, 25b Rotary shaft
26a, 26b Worm
27a, 27b Two-stage gearwheel
28a, 28b Single-stage gearwheel
29 Control unit
30a, 30b Loops
31a, 31b Elongate side parts
32 Operating unit

1. A portable massage device (10), comprising
a sheath (11), having a variable-shape contact segment (12) for resting on a body region to be massaged,
a rotating massage head (13a, 13b),
and
a pummeling massage head (14a, 14b),
the rotating massage head (13a, 13b) and the pummeling massage head (14a, 14b) being arranged within the sheath (11) and being set up to cause a change of shape of the contact segment (12) during operation.

2. The portable massage device according to claim 1, the pummeling massage head (14a, 14b) being part of a massage mechanism which is arranged predominantly within a housing (15), the massage mechanism comprising, in addition to the pummeling massage head (14a, 14b), a drive motor (16), a rotary shaft (17), an eccentric wheel (18a, 18b) and a vibration arm (19a, 19b), the drive motor (16) being drive-connected to the rotary shaft (17), in order to drive the rotary shaft (17) for rotation, and the eccentric wheel (18a, 18b) being placed fixedly on the rotary shaft (17), and the vibration arm (19a, 19b) having an opposite first end and a second end, and the first end of the vibration arm (19a, 19b) being provided with a bore (191) and being placed rotatably on the eccentric wheel (18a, 18b), and a slot (192) being provided at the central position of the vibration arm, the length direction of which slot (192) is identical to the length direction of the vibration arm (18a, 18b), and the vibration arm (18a, 18b) being connected pivotably to the housing (15) such that it can be moved through the slot (192), whereas the second end of the vibration arm extends out of the housing (15) and is connected to the pummeling massage head (14a, 14b).

3. The portable massage device according to claim 2, characterized in that in each case two groups of the eccentric wheels (18a, 18b), the vibration arms (19a, 19b) and the massage heads (14a, 14b) are provided, and they are arranged in each case at the two ends of the rotary shaft (17).

4. The portable massage device according to claim 3, characterized in that the eccentric directions of the two groups of the eccentric wheels (18a, 18b) are arranged in a reversed manner.

5. The portable massage device according to claim 2, characterized in that a relief hole for guiding through the vibration arm (19a, 19b) is provided on the housing (15), a limiting groove being provided on the surface of the housing on an opposite side of the relief hole, and the vibration arm (19a, 19b) being arranged so as to pass through in the relief hole, and a pivoting shaft being arranged so as to pass through in the slot (192) at the central position of the vibration arm, and the pivoting shaft being arranged fixedly in the limiting groove, and the opening of the limiting groove being closed by way of a fixed covering.

6. The portable massage device according to claim 2, characterized in that a mounting groove (21) is provided in the housing (15), the rotary shaft (17) being fastened rotatably in the mounting groove (21) by way of a bearing (20), in order in turn to realize a positioning means in the housing (15).

7. The portable massage device according to claim 2, characterized in that a first belt wheel (22) is connected to a drive end of the drive motor (16), whereas a second belt wheel (23) is placed on the rotary shaft (17), and the first belt wheel and the second belt wheel realizing a transmitting connection to one another by way of a belt (24), and the drive motor (16) driving the rotary shaft (17) for rotation by way of a transmission of the first belt wheel (22), the belt (24) and the second belt wheel (23).

8. The portable massage device according to claim 2, characterized in that a mounting platform is arranged at the second end of the vibration arm (19a, 19b), the pummeling massage head (14a, 14b) being fastened to the mounting platform.

9. The portable massage device according to claim 8, characterized in that the pummeling massage head (14a, 14b) has a hollow hemispherical structure, a first positioning step (141) being arranged on the pummeling massage head, whereas a second positioning step which fits together with the first positioning step (141) is arranged on the mounting platform of the vibration arm (19a, 19b), and the pummeling massage head (14a, 14b) being snapped onto the mounting platform, and a positioning connection being realized by way of the fitting together of the first positioning step (141) and the second positioning step.

10. The portable massage device according to claim 9, characterized in that, furthermore, associated screw holes are provided between the pummeling massage head (14a, 14b) and the mounting platform, and the screw connections between them are realized by means of screw locking elements.

11. The portable massage device according to claim 2, characterized in that the housing (15) comprises an upper housing (15b) and a lower housing (15a) which engage into one another, the drive motor (16) and the rotary shaft (17) being arranged on the lower housing (15a), whereas the slot (192) is connected pivotably to the upper housing (15b) such that it can be moved at the centre position of the vibration arm (19a, 19b).

12. The portable massage device according to claim 1, characterized in that the rotating massage head (13a, 13b) is part of a massage mechanism which is arranged predominantly within a housing, the massage mechanism comprising, in addition to the rotating massage head (13a, 13b), a drive motor (16) and a rotary shaft (25a, 25b), and the drive motor (16) being drive-connected to the rotary shaft (25a, 25b), in order to drive the rotary shaft (25a, 25b) for rotation, and one end of the rotary shaft (25a, 25b) extending out of the housing and being connected fixedly to the rotating massage head (13a, 13b).

13. The portable massage device according to claim 12, characterized in that the driving connection between the drive motor (16) and the rotary shaft (25a, 25b) takes place via a worm (26a, 26b) which is connected to a drive end of the drive motor (16), a two-stage gearwheel (27a, 27b) which is arranged on the worm (26a, 26b), and a single-stage gearwheel (28a, 28b) which is arranged on the two-stage gearwheel (27a, 27b) and on which the rotary shaft (25a, 25b) is arranged, the two-stage gearwheel (27a, 27b) engaging with the worm (26a, 26b), and the single-stage gearwheel (28a, 28b) engaging with the two-stage gearwheel (27a, 27b).

14. The portable massage device according to claim 13, characterized in that in each case two groups of the worms (26a, 26b), the single-stage gearwheels (28a, 28b), the single-stage gearwheels (28a, 28b), the rotary shafts (25a, 25b) and the rotating massage heads (13a, 13b) are provided, and they are arranged in each case at the two ends of the drive shafts of the drive motor (16).

15. The portable massage device according to claim 1, characterized in that the rotating massage head (13a, 13b) has one, two or more elevations which are arranged around the rotational axis of the massage head.

16. The portable massage device according to claim 2, characterized in that the portable massage device (10) comprises merely one drive motor (16) and one housing (15), and the drive motor (15) and the massage mechanism for the rotating massage head (13a, 13b) and the pummeling massage head (14a, 14b) are arranged in the housing.

17. The portable massage device according to claim 2, characterized in that, furthermore, the massage device comprises a control unit (29), a control output of the control unit (29) being connected to an input of the drive motor (16) or the drive motors, in order to actuate the operation of the drive motor (29).

18. The portable massage device according to claim 1, characterized in that the sheath (11) consists completely or predominantly of a textile or leather.

19. The portable massage device according to claim 1, characterized by one or a plurality of heating elements which are arranged within the sheath (11) and are set up to cause heating of the contact segment (12) during operation.

20. The portable massage device according to claim 19, characterized in that the one or the plurality of heating elements is/are arranged in the rotating massage head (13a, 13b) and/or the pummeling massage head (14a, 14b).

21. The portable massage device according to claim 1, characterized in that the rotating massage head (13a, 13b) and the pummeling massage head (14a, 14b) are different massage heads.
